(19) United States
(12) Patent Application Publication
(10) Pub. No.: US 2014/0372907 A1
(43) Pub. Date: Dec. 18, 2014

(54) GESTURE-BASED CONSTRUCTION PROJECT COLLABORATION SYSTEM

(71) Applicant: Industry-Academic Cooperation Foundation, Yonsei University, Seoul (KR)

(72) Inventors: GHANG LEE, Seoul (KR); Jong Sung WON, Seoul (KR)

(21) Appl. No.: 13/919,197

(22) Filed: Jun. 17, 2013

(51) Int. Cl. H04L 29/08

(52) U.S. Cl. CPC H04L 67/10
USPC 715/753

(57) ABSTRACT

A gesture-based construction project collaboration system includes a design information storage for storing a 2D plot or a 3D model of a building; a local information storage for storing local information mapped to location information in the 2D plot or the 3D model; a display for displaying the 2D plot or the 3D model from the design information storage and a desired part of the local information represented by at least one of a touch input and a gesture of a user; a gesture defining section for storing input gestures with respect to types of the local information; and a control section for detecting the location information selected by the user via the touch input on the display, and for controlling the display to display the part of the local information represented by the gesture with respect to the location information.

### BACKGROUND OF THE INVENTION

1. Field of the Invention

The present invention relates to a collaboration system which displays local information while a meeting is being conducted, and more particularly, to a gesture-based construction project collaboration system which conveniently displays location-based local information of a construction site in response to a gesture of a user.

2. Description of the Related Art

An approach which is most widely used for collaboration, such as business coordination, between participating subjects at domestic and overseas construction sites involves conducting a meeting with printed drawings and making records.

Interactive support systems using a large screen were developed in order to at least slightly reduce the inconvenience of conducting a meeting involving documents. Among them, I-Room (interactive room), CAVE (cave automation virtual environment), BIM (building information modeling) construction management integration system of Ssangyong Engineering and Construction Co. Ltd., iTWO (i2 Technologies) and the like are representative examples.

Although I-Room allows the participating subjects to check and update construction models, plots and changes in real time, there is an inconvenience in that, to check the plots or related information, directory folders must be searched for and opened during the meeting and thus the progress of the meeting is momentarily suspended. CAVE requires expensive equipment and a surrounding environment that is complicated to realize, and is directed more towards the provision of an immersive environment rather than amicable collaboration. The BIM system, developed by Ssangyong Engineering and Construction Co. Ltd., or iTWO merely stores and manages BIM information or costs related to processes at the construction stage rather than supporting collaboration at a construction site.

In particular, the above-mentioned techniques commonly have the following problems: Information discussed at the meeting is not swiftly and automatically linked to the BIM model or existing information, and business processes, meetings and follow-up measures to be done after the meetings would be separately carried out, thereby increasing unnecessary tasks. For instance, persons in charge must arrange separate meeting records after meetings.

The information disclosed in the Background of the Invention section is only for the enhancement of understanding of the background of the invention, and should not be taken as an acknowledgment or any form of suggestion that this information forms a prior art that would already be known to a person skilled in the art.

### SUMMARY OF THE INVENTION

Accordingly, the present invention has been made keeping in mind the above problems occurring in the related art, and the present invention proposes a gesture-based construction project collaboration system, which is intended to realize the following objects.

First, it is intended to allow a meeting to be conducted based on local information used at a site by inputting a gesture of a user into a display such as a touch panel.

Second, it is intended to allow a meeting to be conducted based on local information, in which, when a specific location or an object in a two-dimensional (2D) plot or a three-dimensional (3D) model is pointed with one finger [GL1] and a specific gesture is inputted with the other finger, the local [GL2] information of the selected part will be displayed depending on the gesture type.

Third, it is intended to allow persons in charge of the construction site to properly conduct a meeting based on local information displayed on the system of the present invention, so that construction project management and construction can be efficiently carried out.

The objects of the present invention are not limited to those mentioned above, and the other objects which have not been mentioned above will be fully apparent to a person having ordinary skill in the art from the following description.

In order to achieve the above object, according to one aspect of the present invention, there is provided a gesture-based construction project collaboration system that includes: a design information storage for storing a 2D plot or a 3D model of a building; a local information storage for storing local information mapped to location information in the 2D plot or the 3D model; a display for displaying the 2D plot or the 3D model from the design information storage and a desired part of the local information represented by at least one of a touch input and a gesture of a user; a gesture defining section for storing input gestures with respect to types of the local information; and a control section for detecting the location information selected by the user via the touch input on the display, and for controlling the display to display the part of the local information represented by the gesture with respect to the location information.

According to an embodiment of the invention, the local information may include at least one selected from the group consisting of photos of the construction site, drawings, text memos, information about materials, construction schedules, construction costs and personnel information.

According to an embodiment of the invention, the location information may be inputted when the user touches a specific location on the 2D plot or the 3D model displayed on the display.

According to an embodiment of the invention, the local information may be selected by the user who inputs the gesture into the display after touching the specific location.

According to an embodiment of the invention, the gesture-based construction project collaboration system may further include a local information and meeting information transmitting section for transmitting the part of the local information represented by the gesture inputted by the user, to a terminal of a person in charge as wired or wireless.

According to an embodiment of the invention, the gesture-based construction project collaboration system may further include a meeting information inputting section for inputting meeting information by the user, and the control section stores the meeting information in the local information storage by linking the meeting information to the location information.

According to another aspect of the present invention, there is provided a gesture-based construction project collaboration system that includes a design information storage for storing therein a 2D plot or a 3D model about a building; a work place code storage means, being deployed at each work place of a building under construction, for storing location information of each work place; a wireless terminal for inputting local information of a work place and location information of the work place code storage means; a work place mapping section for mapping the location information of the work place code storage means inputted into the wireless terminal to a location numeric data of the work place in the 2D plot or 3D model; a local information storage for storing the local information inputted into the wireless terminal by linking the local information to the location mapped in work place mapping section; a display for displaying the 2D plot or 3D model from the design information storage, and for displaying a desired part of the local information according to at least one of a touch input and a gesture of a user; a gesture defining section for storing input gestures with respect to types of the local information; and a control section for detecting the location information selected by the user via the touch input on the display, and for controlling the display to display the part of the local information represented by the gesture with respect to the location information.

According to an embodiment of the invention, the work place code storage means may include at least one of a work place coordinates tag in a form of a printout having a coordinates of the work place thereon and an electric device type sensor storing coordinates of the work place.

According to an embodiment of the invention, the wireless terminal may include a data input section, including at least one device selected from among a keypad, a touchpad, a microphone and a camera, which receives the local information using the device, and a work place code recognizing section, including at least one device from among a camera, a scanner, a radio frequency identification device (RFID) receiver and a near field communication (NFC) receiver.

According to an embodiment of the invention, the gesture-based construction project collaboration system according to the present invention can support a task coordination meeting at a construction site using only gestures and touches on the screen without an input device such as a mouse. Since multidirectional information, such as instructions discussed at the meeting, photos, information about the schedule, information about persons in charge or so on, is automatically stored and linked to the related plot or model, time and costs can be reduced. In addition, since the present invention can be applied irrespective of languages, it can be applied in foreign markets.

Specifically, the gesture-based construction project collaboration system according to the present invention can: 1) increase the efficiency of communication between participating parties at a construction site by visually and/or intuitively expressing information, 2) improve a task process by automatically storing contents (instructions, information about schedule materials or so on) coordinated in the meeting by linking them to a plot or model of a building, 3) be used as an education system that can be used in a meeting in which tasks are delegated to workers, and 4) be used as a public relations (PR) system which provides image marketing to a client or occupants.

The effects of the present invention are not limited to those mentioned above, and the other effects which have not been mentioned above will be fully apparent to a person having ordinary skill in the art from the following description.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a block diagram schematically showing the configuration of a gesture-based construction project collaboration system according to an embodiment of the present invention;

FIG. 2 shows an example in which a specific location is selected and a gesture is inputted at a 3D model displayed on the display of the gesture-based collaboration system according to the present invention;

FIG. 3 shows an example of local information and a gesture which are mapped at the gesture-defining section of the gesture-based collaboration system according to the present invention;

FIG. 4A to FIG. 4D show examples according to the present invention each of which displays a gesture inputted by a user and a part of local information corresponding to each gesture;

FIG. 5 is a configuration view of the location-based construction project management system shown in FIG. 1, showing the components of the system and a data flow in the system;

FIG. 6 is a block diagram schematically showing the configuration of a gesture-based construction project collaboration system according to another embodiment of the invention; and

FIG. 7 is a configuration view showing the process of collecting local information at the construction project management system shown in FIG. 6.

### DETAILED DESCRIPTION OF THE INVENTION

Reference will now be made in detail to various embodiments of the present invention, examples of which are illustrated in the accompanying drawings and described below. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

While terms such as “first,” “second,” “A” and “B” can be used in describing various elements, it should be understood that these terms do not limit those elements but merely discriminate those elements from others. For instance, first element can be named the second element, and vice versa, without departing the scope of protection of the present invention. The term “and/or” shall include the combination of a plurality of listed items or any of the plurality of listed items.

Unless clearly used otherwise, some expressions in the singular number may include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter a gesture-based construction project collaboration system 100 will be described in detail with reference to the drawings.

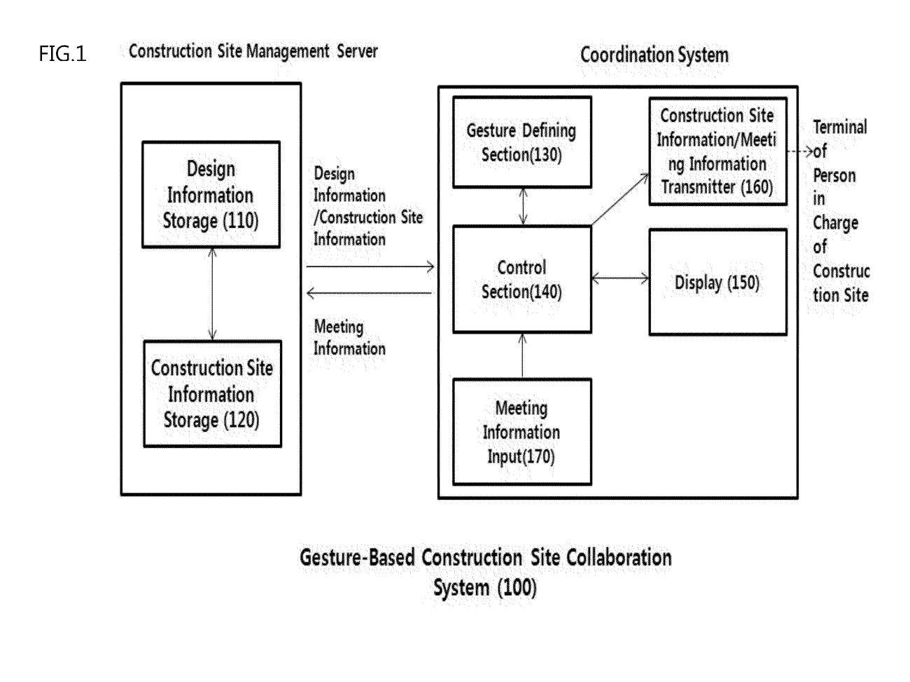

Before the present invention is described in detail with reference to the drawings, it should be understood that constituent elements of the present invention are merely distinguished according to their main functions. Specifically, two or more constituent elements that will be described later may be combined into one constituent element, or one constituent element may be divided into two or more constituent elements having more specified functions. Each constituent element that will be described later may additionally carry out some or all of the functions of another constituent element in addition to its main function, or some of the main functions of one constituent element may be carried out exclusively by another constituent element. Therefore, the presence of the constituent elements which will be described herein should be interpreted based on their functions. The configuration of the constituent elements of a gesture-based construction project collaboration system 100 according to the present invention may be different from FIG. 1 as long as they can realize the object of the present invention.

FIG. 1 is a block diagram schematically showing the configuration of a gesture-based construction project collaboration system 100 according to an embodiment of the present invention.

The gesture-based construction project collaboration system 100 according to the present invention includes: a design information storage 110 which stores therein a 2D plot or 3D model of a building; a local information storage 120 which stores therein local information mapped to location information in the 2D plot or the 3D model stored in the design information storage 110; a gesture defining section 130 in which input gestures are mapped according to types of the local information; a display 150 which displays the 2D plot or the 3D model stored in the design information storage 110, and displays a desired part of the local information by receiving at least one of a touch input and a gesture of a user; and a control section 140 which detects a part of location information selected by the user via the touch input on the display 150, and controls the display 150 to display the part of the local information represented by the gesture inputted into the display 150 by the user, by mapping the gesture to information stored in the gesture defining section 130.

As shown in FIG. 1, it is preferred that the design information storage 110 and the local information storage 120 be basically included in one server. In FIG. 1, a block enclosing the design information storage 110 and the local information storage 120 is referred to as a construction project management server.

According to the present invention, a system that is used at a construction site meeting based on information about the construction site is referred to as a collaboration system. It is preferred that the collaboration system include the gesture defining section 130, the display 150, the control section 140 and a meeting information inputting section 170.

The design information storage 110 basically stores therein the 2D plot or the 3D model. The 3D model used in the present invention is included in data such as building information model (BIM) information, and the local information storage 120 according to the present invention stores the local information mapped according to work places or members.

The term “work place” used herein refers to a specific location of a building or other facilities which are currently under construction. For instance, the work place means a detailed location such as the left wall of a bathroom of a 10^{th} door on a 5^{th} floor of a building or the like.

Although the work place may be a section having a specific area, it may be divided depending on the function of each section if sections which are being constructed in the building have different functions. In addition, the work place may be divided depending on the similarity or relevancy of materials which are used in construction. In an example, the work place can be divided into a variety of locations, such as the entrance in the first floor of an apartment, a lobby in the first floor, section A of the inside wall in the first floor, or so on.

The local information includes photos of the construction site, plots, text memos, information about materials, construction schedules, construction costs, personnel information or so on. Therefore, photos of the construction site, the plots, the information about materials or the like is previously stored with respect to the work place in the local information storage 120.

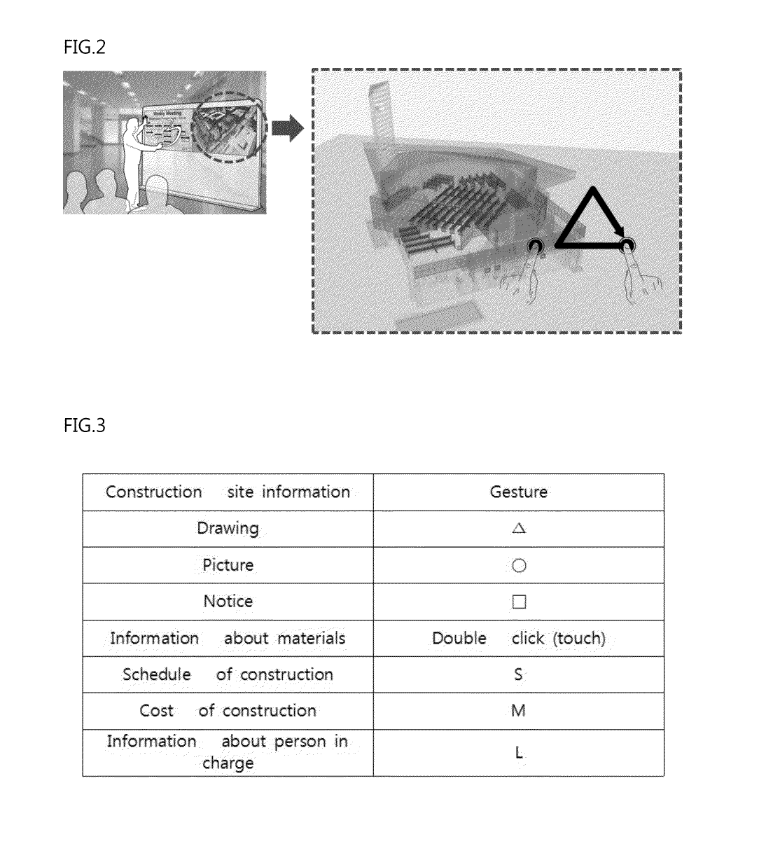

The user can input the location information by touching a specific location in the 2D plot or the 3D model which is displayed on the display 150. FIG. 2 shows an example in which a specific location is selected and a gesture is inputted at a 3D model displayed on the display 150 of the gesture-based collaboration system according to the present invention.

As shown in FIG. 2, when persons in charge are having a meeting at a construction site while viewing contents and 3D models displayed on the display 150 (the left part of FIG. 2), one person in charge who is discussing about the site can input the location information by touching a specific wall portion with the left hand and input a gesture in the form of triangle with the right hand (the right part of FIG. 2). Then, local information designated by the gesture is displayed. FIG. 2 shows only a screen into which specific location information is inputted and a screen into which the gesture is inputted without showing a screen on which the local information is displayed.

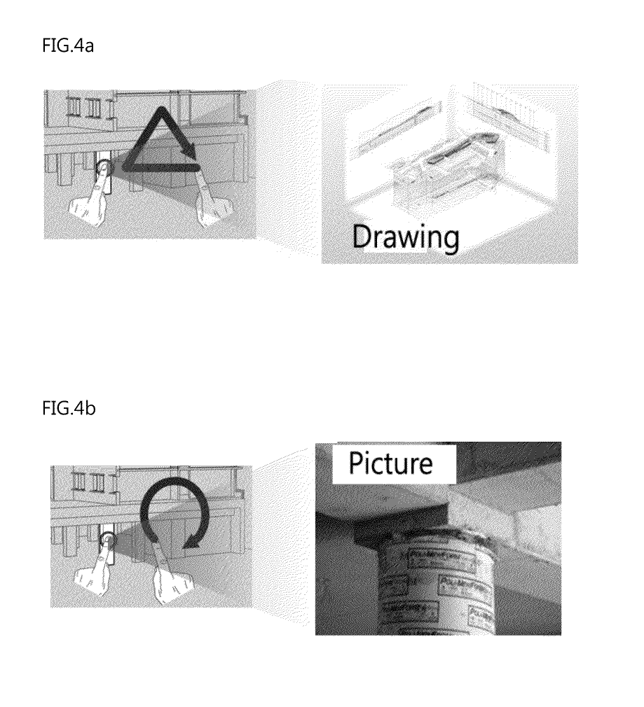

FIG. 3 shows an example of local information and a gesture which are mapped at the gesture defining section 130 of the gesture-based collaboration system according to the present invention.

The table shown in FIG. 3 corresponds to an implementation of the present invention, in which a triangular gesture (Δ) represents a plot, a circular gesture (∘) represents a photo, and a rectangular gesture (□) represents a notice made up by a person in charge. Other data, such as information about materials, construction schedules, construction costs and personnel information, are represented by different gestures. Of course, various kinds of information other than the local information shown in FIG. 3 can be stored in the table, and a separate gesture can be designated to each kind of information.

Although a variety of techniques is possible, the present invention basically uses a multi-touch technique of selecting a specific location with one hand and inputting a gesture with the other hand. The user can select any part of the local information by inputting a specific gesture into the display 150 after touching a specific location.

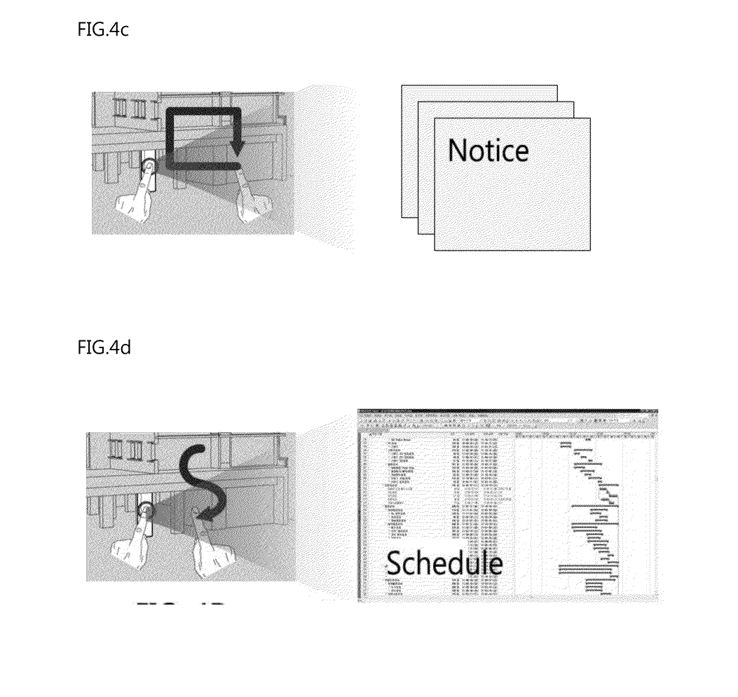

FIG. 4A to FIG. 4D show examples according to the present invention each of which displays a gesture inputted by a user and a part of local information corresponding to each gesture. FIG. 4A to FIG. 4D show screens each of which displays a part of local information depending on the gesture. FIG. 4A to FIG. 4D sequentially show a plot depending on a triangular gesture, a photo depending on a circular gesture, a notice depending on an oblong gesture, and schedule information depending on an S-shaped gesture.

The gesture-based construction project collaboration system 100 according to the present invention can also include the meeting information inputting section 170 which transmits additional local information to the local information storage 120 by automatically linking it to the location information that the user inputted into the display 150.

The meeting information refers to data or contents that are introduced in the meeting between persons in charge (users) at the construction site. The meeting information includes a schedule change for a specific site, designation of a person in charge, a change of a material, or so on. The meeting information also corresponds to location-based information. That is, the meeting information is information about a specific work place in the 2D plot or the 3D model or an area including the specific work place. Therefore, it is preferred that the meeting information be stored in the local information storage 120 which is linked to design information storage 110 and stores the corresponding location information therein.

The gesture-based construction project collaboration system 100 according to the present invention can also include a local information and meeting information transmitting section 160 which transmits the local information that a gesture inputted by the user represents and/or the meeting information via wired or wireless media to a terminal of the person in charge of the construction site.

That is, desired information is shared between persons in charge or contents/data discussed in the meeting are sent to a person in charge of a specific site using the local information and meeting information transmitting section 160.

The situation shown in FIG. 2 will be described as an example. It shall be assumed that a meeting about walls of a specific construction structure is being held among persons in charge. It is possible to describe the contents/data pertaining to the corresponding work place discussed among the persons in charge in a notice, additionally submit a separate photo or plot, or additionally designate a person to be in charge of the corresponding area. When one or more of the notice, the photo, the plot and the information about persons in charge is newly inputted or updated through the meeting information inputting section 170, the corresponding information is automatically linked to a wall, or the current specific location, and is stored in the local information storage 120.

The meeting information inputting section 170 is a computer device linked to the gesture-based construction project collaboration system 100, preferably, a device including an input device, such as a keyboard, a mouse, a touch panel or so on. Furthermore, as shown in FIG. 1, it is preferred that the control section 140 be connected to the meeting information inputting section 170 and the local information and meeting information transmitting section 160, and control the overall flow of data.

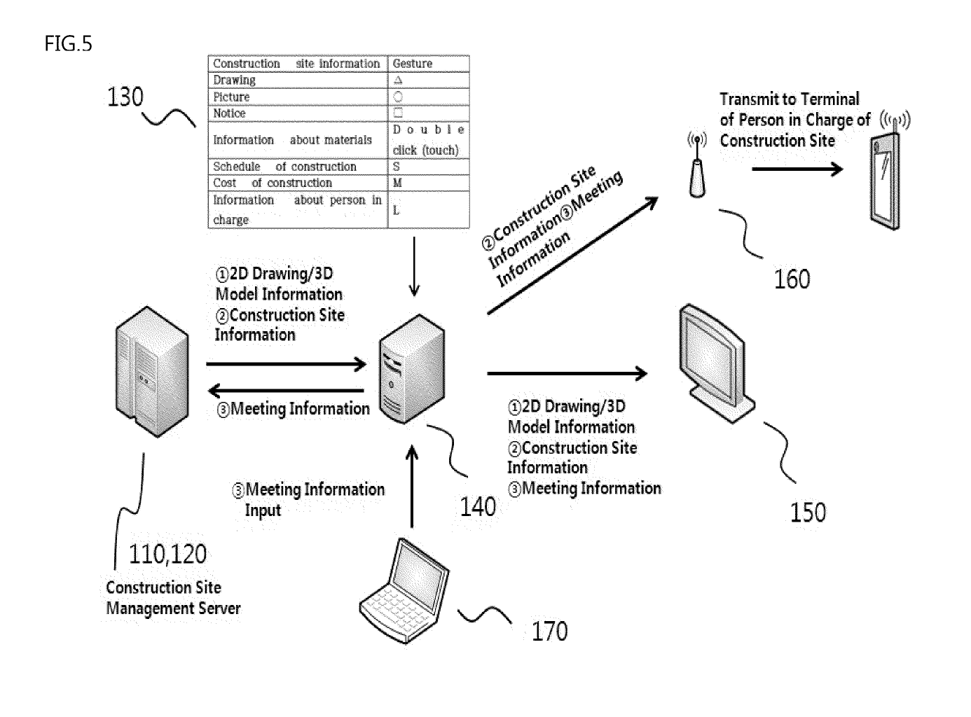

FIG. 5 is a configuration view of the location-based construction project management system shown in FIG. 1, showing the components of the system and a data flow in the system.

When the design information storage 110, included within the construction project management server, sends information about the 2D plot or 3D model to the control section 140, the control section 140 sends the corresponding information to the display 150. The user selects a specific location in the 2D plot or 3D model displayed on the display 150, and inputs a gesture. The control section 140 determines which part of local information the input gesture represents using the gesture defining section 130, brings in the part of information which the gesture represents among from the local information about the corresponding location, and transmits the part of information to the display 150. It is possible to transmit local information to the terminal of the person in charge via the local information and meeting information transmitting section 160 or store local information added during the meeting in the local information storage 120 via the meeting information inputting section 170.

The gesture defining section 130 can be implemented in a variety of types. The gesture defining section 130 can be linked to the display 150, and when a specific gesture is inputted, send the specific gesture as specific local information to the control section 140.

As shown in FIG. 1 and FIG. 5, the gesture defining section 130 can be implemented as one that is linked to the control section 140. In this case, when a specific gesture is inputted into the display 150, information about the input gesture is sent to the control section 140, which maps the specific site information to which the gesture represents using the gesture defining section 130, and thereby brings in corresponding site information from the local information storage 120.

A description will be given below of a gesture-based construction project collaboration system 200 according to another embodiment of the present invention. In the above-described system, it was assumed that local information is previously stored in the local information storage. The system which will be described below is a system which enables local information to be automatically linked to a 2D plot or 3D model and stored in a local information storage 220. As a result, this embodiment of the present invention provides the construction project collaboration system 200 which collects information at a site and displays the information based on a gesture at the site. In the following description, some features will be described in brief since they are identical to those of the above-described gesture-based construction project collaboration system 100.

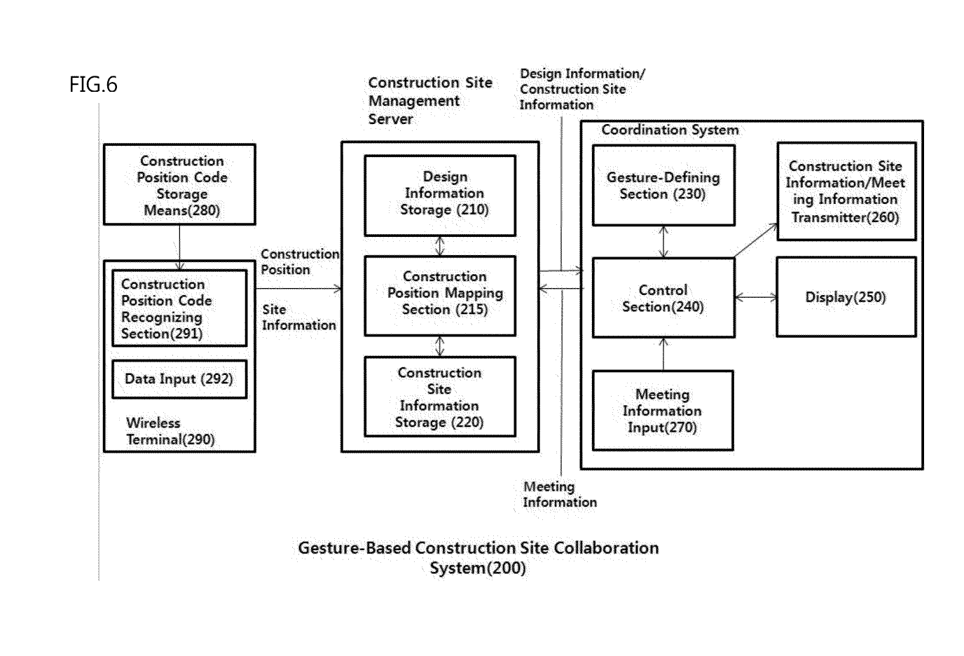

FIG. 6 is a block diagram schematically showing the configuration of the gesture-based construction project collaboration system 200 according to another embodiment of the present invention.

The gesture-based construction project collaboration system 200 according to another embodiment of the present invention includes a design information storage 210 which stores therein a 2D plot or a 3D model about a building; work place code storage means 280 which are arranged at each work place of a building that is under construction, and store therein location information of each work place; a wireless terminal 290 into which local information of a work place and location information of the work place code storage means 280 are inputted; a work place mapping section 215 in which the location information of the work place code storage means 280 inputted into the wireless terminal 290 is mapped to a location numeric data of the work place in the 2D plot or 3D model stored in the design information storage 210; a local information storage 220 which stores therein the local information inputted into the wireless terminal 290 by linking the local information to a location mapped in work place mapping section 215; a gesture defining section 230 in which input gestures are mapped according to types of the local information; a display 250 which displays the 2D plot or 3D model stored in the design information storage 210, and displays a desired part of the local information by receiving at least one of a touch input and a gesture of a user; and a control section 240 which detects location information that the user selects by making the touch input on the display 250, and controls the display 250 to display a part of the local information represented by the gesture, which the user inputted into the display 250, by mapping the gesture to information stored in the gesture defining section 230.

It is preferred that the design information storage 210, the work place mapping section 215 and the local information storage 220 be basically included in one integrated server.

The work place code storage means 280 are arranged at each work place, and are means in which a unique code, or location information, for identifying a work place is stored. The work place code storage means 280 may be at least one of a work place coordinate tag in the form of a printout whereon the coordinate value of the work place is printed or an electronic device type sensor wherein the coordinate value of the work place is stored.

The work place coordinate tag may use a QR code, a bar code or the like. The sensor may be implemented as one or more of a near field communication (NFC) tag or a radio frequency identification device (RFID) tag. The RFID tag is divided into an active RFID tag and an inactive RFID tag. The active RFID tag which transmits information by automatically recognizing an RFID receiver is more preferable.

The work place coordinate tag or the sensor stores therein the unique code of the work place, whereby the location in the 2D plot or the 3D model stored in the design information storage section 210 can be detected.

In the meantime, the work place coordinate tag or the sensor according to the present invention may be substituted with a variety of marks or devices that a person having ordinary skill in the art can use. It is preferred that at least one work place coordinate tag or sensor be disposed at every work place.

A variety of methods can be used in order to detect the work place. For instance, it shall be assumed that a work place coordinate tag or sensor attached to a bathroom of a 10^{th} door on a 5^{th} floor of a building contains therein a work place code from which information including the direction can be acquired.

First, it is possible to dispose coordinate tags or sensors on all of four walls and transmit the work place code of each wall via the wireless terminal, so that site information can be stored in a construction project management system. However, this method increases costs because a large number of coordinate tags are required.

Second, it is possible to dispose the work place coordinate tag or sensor, where the work place code including the direction information is stored, on only one wall, and check the direction information of the wall using a direction sensor of the wireless terminal 290. Therefore, the second method is more preferable.

Assuming that the work place coordinate tag is disposed on the left wall of the bathroom of the 10^{th} door on the 5^{th} floor of the building, the work place coordinate tag contains therein information representing that the location where the coordinate tag is disposed at present is the left wall of the bathroom. When a person in charge of the construction site turns the wireless terminal 290 to the left or right with respect to the direction in which the coordinate tag is disposed, the direction sensor inside the wireless terminal can recognize the direction in which the front section of the wireless terminal 290 is oriented at present.

The direction (relative direction) in which the front section of the wireless terminal 290 faces at present is acquired based on the work place and the direction (reference direction) stored in the work place coordinate tag on the left wall. The relative direction together with the construction code stored in the work place coordinate tag is sent to the work place mapping section 215. Consequently, the information including even the specific direction at the construction site is sent to the work place mapping section 215.

The wireless terminal 290 includes a data input section 292 and a work place code recognizing section 121. The data input section 292 includes at least one device selected from among a keypad, a touchpad, a microphone and a camera, and receives site information using that device(s). The work place code recognizing section 292 includes at least one device selected from among a camera, a scanner, an RFID receiver and an NFC receiver.

It is preferred that the data input section 292 with which the person in charge of the construction site inputs the site information be included in the wireless terminal 290. However, this is not intended to be limiting. It is of course possible to use input means that are physically separate from the wireless terminal 290.

The work place code recognizing section 291 is a component into which the code stored in the work place code storage means 280 is inputted, and the data input section 292 is a component into which the site information of the work place is inputted.

The QR code or bar code can be a printout that is attached at a specific location of the work place. The coordinate information of the present work place stored in the QR code or bar code is inputted into the wireless terminal 290 via the camera or scanner of the work place code recognizing section 291.

In the case of the active RFID, as the RFID receiver included in the work place code recognizing section 291 approaches the active RFID tag, the work place is automatically transmitted to the RFID receiver.

The wireless terminal 290 according to the present invention can be one of various types of wireless terminals. The wireless terminal 290 transmits the information of the work place coordinate tag or the sensor to the work place mapping section 215 using the work place code recognizing section 291, and transmits the site information of the work place to the local information storage section 220 using the work place code recognizing section 291.

The wireless terminal 290 according to the present invention can be implemented as a mobile communication terminal that is distributed to each individual. For instance, it is possible to photograph the QR code or the like using the camera of the mobile communication terminal or receive the work place code using the RFID receiver which can perform data communication with the mobile communication terminal, and receive image information, dynamic image information, text information or voice information about the site using the camera, keypad, touchpad or microphone of the mobile communication terminal.

Specific site information may be at least one selected from among a photo of the work place, information about site materials used at the work place, information about a person in charge of the work place, a site construction schedule for the work place, costs of construction of the work place, information about whether or not the work place has been inspected and a notice explaining the status of the construction at the work place.

The design information storage section 210, the local information storage section 220 and the work place mapping section 215 have been described as separate components, since they have different functions. However, as shown in FIG. 6, they are basically located in the same construction project management server. Of course, they may be located in different servers, or the work place mapping section 215 may be implemented as an application that runs in the wireless terminal 290. When the work place mapping section 215 is separately configured, the computer having the work place mapping section 215 disposed therein acts as a clouding computer.

The work place mapping section 215 receives the construction code information, or the work place information stored in the work place code storage means 280, from the wireless terminal 290, and maps a location numeric data (coordinate information or the like) of a correct work place in the 2D plot or the 3D model stored in the design information storage section 210.

The route along which the site information is finally inputted into the local information storage section 220 can be one of a variety of routes. First, the work place mapping section 215 can store the site information received from the wireless terminal 290 at the location numeric data of the work place by linking it to the corresponding location in the 2D plot or the 3D model. Second, the wireless terminal 290 can send the site information to the local information storage section 220, and store it linked to the location numeric data of the work place of the work place mapping section 215.

The person in charge of the construction site is required to check construction-related notices which were recorded in advance while examining the work place stored in the local information storage section 220. This is because it is necessary to check whether or not any problems that occurred at the site after the site information was inputted have been solved. In addition, the person in charge of the work place may be required to inspect the plot of the work place.

For this, the wireless terminal 290 can receive information about the 2D plot or the 3D model stored in the design information storage section 210 and display it thereon, or receive the site information stored in the local information storage section 220 and display it thereon. Referring to FIG. 1 and FIG. 2, this corresponds to data that are sent from the construction project management server to the wireless terminal 290.

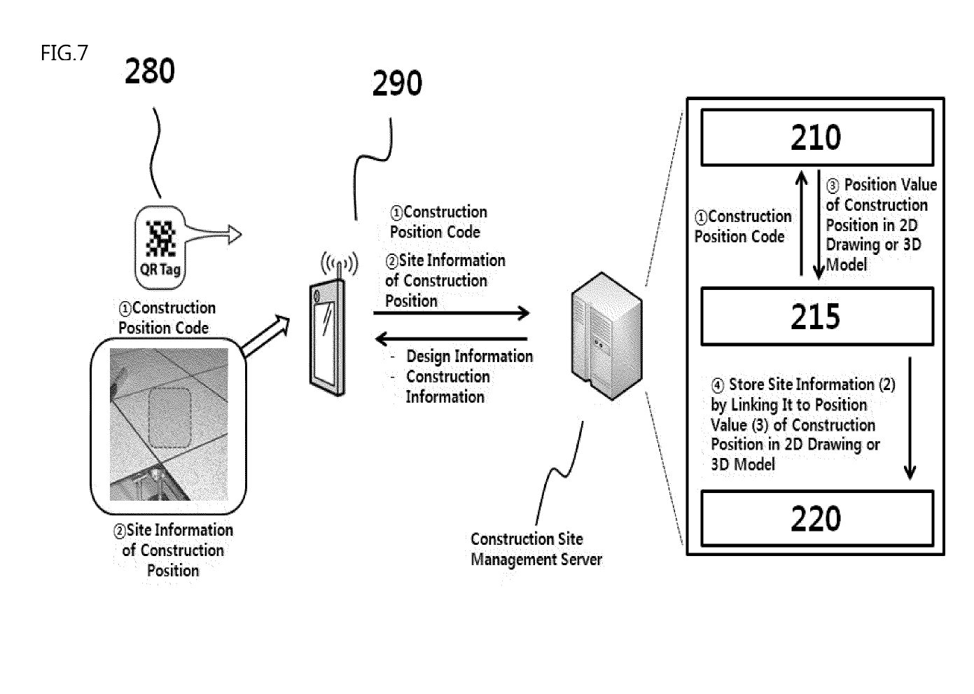

FIG. 7 is a configuration view showing the process of collecting local information at the construction project management system shown in FIG. 6.

The work place coordinate tag is shown in FIG. 7 as being a QR tag by way of example. The QR tag is photographed using the wireless terminal 290 of the person in charge of the construction site and is sent to the work place mapping section 215, which in turn maps the location numeric data of the work place in the 2D plot or the 3D model using the work place code stored in the QR tag. The site information is stored depending on the mapped location numeric data of the work place in the local information storage section 220.

The person in charge of the construction site collects the site information of the construction site using the data input section 292 of the wireless terminal 290. In FIG. 7, the specific photograph of the work place is depicted as being taken using a camera by way of example. The site information collected in this fashion is stored in the local information storage section 220, and linked to the location numeric data of the work place detected by the work place mapping section 215. Consequently, the collected site information is automatically linked in real time to the corresponding location in the 2D plot or the 3D model. Therefore, it is possible to manage the construction site using the collected site information.

The local information is stored in the local information storage 220 via the above-described configuration, and the user can check necessary information by inputting a gesture into the display 250.

The local information includes at least one selected from among photos of the construction site, plots, text memos, information about materials, a construction schedule, construction costs, personnel information or so on. In addition, this embodiment of the present invention can also include a local information and meeting information transmitting section 260 which transmits the local information that the gesture inputted by the user represents and/or the meeting information via wired or wireless media to the wireless terminal 290, or a meeting information inputting section 270 which transmits the additional local information to the local information storage 220 by automatically linking it to the location information that the user inputted into the display 250. That is, only the components for collecting the local information are added, but the other components are the same as those of the above-described gesture-based construction project collaboration system 100.

Although the exemplary embodiments of the present invention have been described for illustrative purposes, those skilled in the art will appreciate that various modifications, additions and substitutions are possible, without departing from the scope and spirit of the present invention as disclosed in the accompanying claims.

What is claimed is:

1. A gesture-based construction project collaboration system comprising:
a design information storage for storing a 2D plot or a 3D model of a building;
a local information storage for storing local information mapped to location information in the 2D plot or the 3D model;
a display for displaying the 2D plot or the 3D model from the design information storage and a desired part of the local information represented by at least one of a touch input and a gesture of a user;
a gesture defining section for storing input gestures with respect to types of the local information; and
a control section for detecting the location information selected by the user via the touch input on the display, and for controlling the display to display the part of the local information represented by the gesture with respect to the location information.

2. The gesture-based construction project collaboration system according to claim 1, wherein the local information comprises at least one selected from the group consisting of photos of the construction site, plots, text memos, information about materials, construction schedules, construction costs and personnel information.

3. The gesture-based construction project collaboration system according to claim 1, wherein the location information is inputted when the user touches a specific location on the 2D plot or the 3D model displayed on the display.

4. The gesture-based construction project collaboration system according to claim 3, wherein the local information is selected by the user who inputs the gesture into the display after touching the specific location.

5. The gesture-based construction project collaboration system according to claim 1, further comprising a local information and meeting information transmitting section for transmitting the part of the local information represented by the gesture inputted by the user, to a terminal of a person in charge as wired or wireless.

6. The gesture-based construction project collaboration system according to claim 1, further comprising a meeting information inputting section for inputting meeting information by the user,
wherein the control section stores the meeting information in the local information storage by linking the meeting information to the location information.

7. A gesture-based construction project collaboration system comprising:
a design information storage for storing therein a 2D plot or a 3D model about a building;
a work place code storage means, being deployed at each work place of a building under construction, for storing location information of each work place;
a wireless terminal for inputting local information of a work place and location information of the work place code storage means;
a work place mapping section for mapping the location information of the work place code storage means inputted into the wireless terminal to a location numeric data of the work place in the 2D plot or 3D model;
a local information storage for storing the local information inputted into the wireless terminal by linking the local information to the location mapped in work place mapping section;
a display for displaying the 2D plot or 3D model from the design information storage, and for displaying a desired part of the local information according to at least one of a touch input and a gesture of a user;
a gesture defining section for storing input gestures with respect to types of the local information; and
a control section for detecting the location information selected by the user via the touch input on the display, and for controlling the display to display the part of the local information represented by the gesture with respect to the location information.

8. The gesture-based construction project collaboration system according to claim 7, wherein the work place code storage means comprise at least one of a work place coordinates tag in a form of a printout having a coordinates of the work place thereon and an electric device type sensor storing coordinates of the work place.

9. The gesture-based construction project collaboration system according to claim 7, the wireless terminal comprises:
a data input section, including at least one device selected from among a keypad, a touchpad, a microphone and a camera, the data input section receiving the local information using the device; and
a work place code recognizing section, including at least one device from among a camera, a scanner, a radio frequency identification device (RFID) receiver and a near field communication (NFC) receiver.

10. The gesture-based construction project collaboration system according to claim 7, wherein the local information comprises at least one selected from the group consisting of photos of a construction site, plots, text memos, information about materials, construction schedules, construction costs and personnel information.

11. The gesture-based construction project collaboration system according to claim 7, wherein the location information is inputted when the user touches a specific location on the 2D plot or the 3D model displayed on the display.

12. The gesture-based construction project collaboration system according to claim 11, wherein the local information is selected by the user who inputs the gesture into the display after touching the specific location.

13. The gesture-based construction project collaboration system according to claim 7, further comprising a local information and meeting information transmitting section for transmitting the part of the local information represented by the gesture inputted by the user, to the wireless terminal.

14. The gesture-based construction project collaboration system according to claim 7, further comprising a meeting information inputting section for inputting meeting information by the user,
wherein the control section stores the meeting information in the local information storage by linking the meeting information to the location information.
